(19) United States
(12) Patent Application Publication
(10) Pub. No.: US 2011/0005871 A1
(43) Pub. Date: Jan. 13, 2011

(54) Pneumatically Actuated Disc Brake with Actuation Tappet

(75) Inventors: Aleksandar PERICEVIC, Muenchen (DE); Johann BAUMGARTNER, Moosburg (DE); Robert GRUBER, Pfaffing (DE); Robert TRIMPE, Wessling (DE); Walter SAUTER, Lappersdorf-Lorenzen (DE)

Correspondence Address: CROWELL & MORING LLP;INTELLECTUAL PROPERTY GROUP, P.O. BOX 14300, WASHINGTON, DC, 20044-4300, US

(73) Assignee: KNORR-BREMSE Systeme fuer Nutzfahrzeuge GmbH, Muenchen (DE)

(21) Appl. No.: 12/837,744

(22) Filed: Jul. 16, 2010

Related U.S. Application Data
(63) Continuation of application No. PCT/EP2009/000055, filed on Jan. 8, 2009.

(30) Foreign Application Priority Data
Jan. 17, 2008 (DE) 10 2008 004 806.2

(51) Int. Cl. F16D 55/22; F16D 65/52; F16D 55/226; F16D 65/20

(52) U.S. Cl. 188/71.8; 188/72.3

(57) ABSTRACT

A pneumatically actuated disc brake, includes a caliper, at least one brake application-side and one reaction-side brake lining, a brake disc, and a brake cylinder to which compressed air can be applied as a braking force generator. The brake cylinder acts on a brake application device for applying the brake lining, the brake application device having a rotary lever. At least the brake application-side brake lining can be moved both in a direction parallel to the brake disc rotation axis and parallel to the brake disc frictional surface, and a self-energizing device is provided which has a self-energizing factor that is selected such that the brake releases automatically after braking.

### CROSS-REFERENCE TO RELATED APPLICATIONS

This application is a continuation of PCT International Application No. PCT/EP2009/000055, filed Jan. 8, 2009, which claims priority under 35 U.S.C. §119 from German Patent Application No. DE 10 2008 004 806.2, filed Jan. 17, 2008, the entire disclosures of which are herein expressly incorporated by reference.

### BACKGROUND AND SUMMARY OF THE INVENTION

The invention relates to a pneumatically actuated disc brake including a caliper, at least one application-side brake lining, one reaction side brake lining, and a brake disc. A compressed air-actuated brake cylinder provides a brake force generator, which acts on a brake application device having a rotary lever for application of the brake lining against the disc.

Pneumatically actuated disc brakes are known in the art, as disclosed, for example, by DE 40 32 885 A1 or WO 97/22 814. It is desirable to reduce the space occupied by such brakes together with their weight, and in particular the overall space taken up by the associated actuator, i.e., the brake cylinder. The brake is intended to have the operating characteristics of the compressed air-actuated brake, however, such as reliable automatic release and the capacity for precise proportioning of the braking action. Similarly, the simplicity, robustness and low manufacturing costs of a compressed air-actuated disc brake are to be retained.

The object of the invention is to provide such a desirable disc brake.

The invention achieves this object by providing a pneumatically actuated disc brake including a caliper, at least one application-side brake lining, one reaction side brake lining, and a brake disc. A compressed air-actuated brake cylinder provides a brake force generator, which acts on a brake application device having a rotary lever for application of the brake lining against the disc. At least the application side brake lining is moveable both in a direction parallel to the axis of rotation of the brake disc and parallel to the brake disc friction surface. A self-energizing device is provided, which has a self-energizing factor that is selected such that the brake releases automatically after braking.

In drum brakes, the use of self-energization is inherent in the system. Compressed air-actuated drum brakes for heavy commercial vehicles also have self-energization, although different types rely on this to varying degrees.

In expansion wedge-actuated duo-duplex drum brakes a high degree of self-energization is achieved. Such brakes were used as compressed air-actuated brakes in heavy commercial vehicles, but did not gain any wider acceptance since the high degree of self-energization and a limited variability resulted in an uneven braking action and uneven wear properties.

Until the introduction of the compressed air-actuated disc brake, simplex drum brakes with S-cam actuation were virtually the only brake equipment available for heavy commercial vehicles. The particular advantage of this type of drum brake is that owing to the firm application by means of the S-cam, the self-energizing effects are moderated and, above all, the wear to the leading and trailing brake shoes in the brake is evened out. Even in S-cam brakes, however, there are still relatively large differences in braking force together with uneven braking action and an uncomfortable response behavior on the part of the brake.

In western Europe the S-cam drum brakes have largely been superseded by compressed air-actuated disc brakes, the very absence of a self-energizing effect with the associated drawbacks being seen as their main inherent advantage.

An altogether different situation prevails in the case of electromotor-actuated disc brakes, where the interest lies in using self-energization in an attempt to reduce the otherwise extremely high electrical energy demand of this type of brake. Moreover, in operation electromotor-actuated brakes can be position-controlled so that the effects of self-energization on the operating performance of the brake remain more manageable (see, for example, DE 101 56 348, DE 101 39 913.8 or DE 10 2005 030 618.7 and DE 10 2006 036 279.9 or WO 2007/082658).

On the strength of experiences with self-energizing drum brakes, the use of self-energization was simply not an aim in the case of compressed air-actuated disc brakes, since in itself the provision of actuating energy does not present a significant problem. The invention represents a departure from this trend, since in future vehicle and axle concepts the overall space taken up by the actuating cylinders increasingly poses a problem. In particular, the spring energy accumulator needed to provide the parking brake function makes installation of the brake considerably more difficult. This is one particular problem remedied by the disc brake according to the invention, in which the brake application device, in addition to the rotary lever, preferably includes a self-energizing device, and at least the application-side brake lining is displaceable both in a direction parallel to the axis of rotation of the brake disc and parallel to the brake disc friction surface. The self-energizing device is preferably connected in parallel to the brake application device.

In this way, the power requirement of the brake cylinder is reduced by the use of self-energizing effects, also resulting in a reduction of the overall space. The advantageous operating properties of the brake are nevertheless retained. The concept of self-energization in a pneumatically actuated disc brake is augmented to particular advantage, since a considerable reduction in the overall size of the brake cylinders and spring energy accumulators is possible even with relatively small self-energizing factors. Here, through appropriate dimensioning of the wedge or ramp angle, the self-energization is selected so that even at a maximum possible coefficient of friction of the brake linings, a reliably automatic release of the brake ensues. This means that in contrast to electromotor-actuated disc brakes, the force generator for applying the brake does not also have to be used to release the brake. With such a design it is still possible to achieve a self-energizing factor of approximately 2.

This will be explained in more detail with reference to an example. Given a design coefficient of friction of 0.375, the coefficient of friction occurring in operation may be between 0.3 and 0.45, assuming a scatter range of ±20%. On the basis of these friction lining characteristics a reliable return behavior with return forces still high enough for rapid automatic release can be obtained if the wedge or ramp angle α is selected so that, allowing for mechanical losses, tan(α) is equal to a value eta*μ=0.65 (eta=mechanical efficiency, μ=lining coefficient of friction).

With such a design not only the overall space and the energy requirement of the service brake cylinder but also the necessary adjusting energy of the parking brake spring energy accumulator are halved since, owing to the gravitational force component to cant, when stopping the vehicle on a gradient the self-energizing is also operative in the case of the parking brake.

It is possible, particularly if the transmission of high return forces can be dispensed with, to reduce the outlay for the bearing. A simplified bearing concept with half-shell rolling bearings is possible, as in the disc brakes of the ‘Knorr-Bremse SN6 or SN7’ type currently in routine service, or with ‘spherical slide bearings’, as described in WO 2007/082658.

The retractile attachment of the pressure plate to the actuating piston seems advisable. The force of the inner return spring is thereby utilized for returning the brake lining after a braking sequence and the pretensioning between the rolling elements and the ramp faces on the booster pistons is maintained. The fact that only small retraction forces are required also means that a simplified solution in the form of a clip-in pin or bearing ball, which are easier to assemble, is feasible.

Particular advantages of the brake concept described are:

smaller brake cylinders and spring energy accumulators;

smaller dimensions of the compressor and other air supply components owing to the smaller compressed air demand of the brake system;

smaller energy demand for the air supply to the brake system;

no radical changes in the brake control technology: for brake control purposes the brake behaves like a normal compressed air-actuated brake; and

fully redundant brake system using self-energization.

Advantageous scope for development results from:

a type of brake having a centrally arranged actuating piston actuated by the brake cylinder by means of a brake lever, and two booster pistons arranged in parallel;

a guide plate, which transmits the circumferential force of the booster pistons directly to the brake component fixed to the axle;

a pivotally crossing bearing support of the actuating piston; and

a selection of the self-energization, so that allowing for the mechanical losses the tangential return force acting on the wedge system at the maximum possible coefficient of friction of the brake lining is still high enough to produce sufficiently rapid automatic release even in the case of ABS control processes. From experience a coefficient of friction scatter range of ±20% of the design coefficient of friction may be assumed for determining the maximum possible coefficient of friction of the lining.

The minimum tangential return force required was calculated as approximately 10% of the total application force of the brake. The value varies as a function of the level of frictional resistances and the moving masses. At first sight this value seems low, since in a normal compressed air-actuated disc brake without self-energization, the entire application force of the brake is available for rapid release. An analysis of the release process, however, shows that the release time is determined substantially by the flow resistance when venting the brake cylinder. Since in the self-energizing brake a considerably smaller air volume also has to be exhausted, the influence of the smaller return force is compensated for.

Taking into account the proportion of the application force, amounting to approximately 50%, resulting from the self-energization, and the possible maximum effective area of the brake or combination cylinder, the transmission ratio of the brake lever is selected so that the stroke and hence the required overall length of the cylinder is minimized.

Alternatively, applications in which the diameter of the cylinder is to be minimized are also feasible. The transmission ratio is then minimized in a correspondingly different manner.

The retractably clipped-in pivot bearing of the pressure plate should also be mentioned as a further advantage.

The pneumatically actuated disc brake with self-energization also does not need any sophisticated control in order achieve satisfactory vehicle braking performance despite the fluctuations in the coefficient of friction suggested for proposed degrees of self-energization.

With the degree of self-energization proposed herein, the braking performance even of a heavy commercial vehicle is still surprisingly possible even without electronic control or solely on the basis of control and feedback systems, such as an ABS system or EBS system, generally now provided on modern vehicles with pneumatically actuated brakes. What is more, this is possible even without any facility for assisting the release of the disc brake through use of the brake application actuator.

It is particularly advantageous here to use a lever actuation having a rotary lever with an axis of rotation perpendicular to the axis of rotation of the brake disc also for the application of a self-energizing disc brake with a pneumatic actuator. The actuation tappet is pivotally supported on the brake rotary lever and on the pressure plate or the application-side brake lining with the—preferably crossing—axis of rotation, which is a simple way of allowing the concept of the rotary lever actuation to be used also for self-energizing disc brakes.

Furthermore the actuation tappet is preferably pivotally attached to the brake rotary lever and to the pressure plate or the application-side brake lining in such a way that it can transmit tensile and compressive forces between the brake lining and its drive (for example an electric motor with a threaded drive).

The concept of the actuation tappet or actuating piston should not be interpreted too narrowly. It also encompasses, in particular, units of variable length comprising a plurality of elements.

It is especially preferred if the actuation tappet is supported on the eccentric axis of rotation of the brake rotary lever and attached to the pressure plate or to the application-side brake lining such that swivel movements of the brake rotary lever and circumferential slipping movements of the brake lining and possibly the pressure plate can be compensated for by swiveling in both swiveling directions perpendicular to one another. Whilst taking up little overall space this allows both the circumferential movement of the pressure plate necessary to obtain the self-energizing effect and also a compensation for the tilting movement of the actuation tappet due to the exclusively rotational guidance in the eccentric of the brake rotary lever.

The actuation tappet unit is preferably equipped with swivel bearings, for example sliding spherical cap bearings, at both fitting ends.

In addition, according to an especially advantageous development it is also possible to introduce the adjusting rotational movement into the actuation tappet pivoting in two directions. For this purpose the actuation tappet is first formed as a unit of axially variable, in particular telescopic length, which allows a variation in the length of the brake piston to compensate for lining and/or disc wear. The actuation tappet unit preferably includes an actuation tappet and a threaded spindle, and is coupled to an adjusting device by way of a synchronization mechanism.

It is especially preferred if the actuation tappet unit including the actuation tappet and the threaded spindle is simply structurally connected to a gearwheel for transmitting the adjusting rotational movement. In this case, the gearwheel is preferably designed so that when the brake is not actuated, that is to say in the rest position of the actuation tappet, a tight backlash exists with the other coupled gearwheels. When the brake is actuated, however, the gearwheels are sufficiently disengaged by the application movement of the actuation tappet to allow the ensuing swivel movement of the actuation tappet.

Alternative embodiments of the pivot bearings on the brake rotary lever—eccentric axis of rotation and on the pressure plate attachment of the actuation tappet are also possible.

A fixed component of the self-energizing device, which is connected to the adjusting device, is preferably accommodated with little clearance parallel to the brake disc axis of rotation between guide faces of the brake component fixed to the axle such that in braking the circumferential forces occurring are braced directly against the brake component fixed to the axle by this fixed component of the self-energizing device.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a first sectional view of a sliding caliper disc brake having a brake cylinder housing;

FIG. 2 shows the disc brake in FIG. 1 with a schematically comparative representation of two different-sized brake cylinders attached to the disc brake;

FIG. 3 shows a further sectional view through the disc brake in FIG. 1 perpendicular to FIG. 1;

FIG. 4 shows a perspective representation of the disc brake in FIG. 1; and

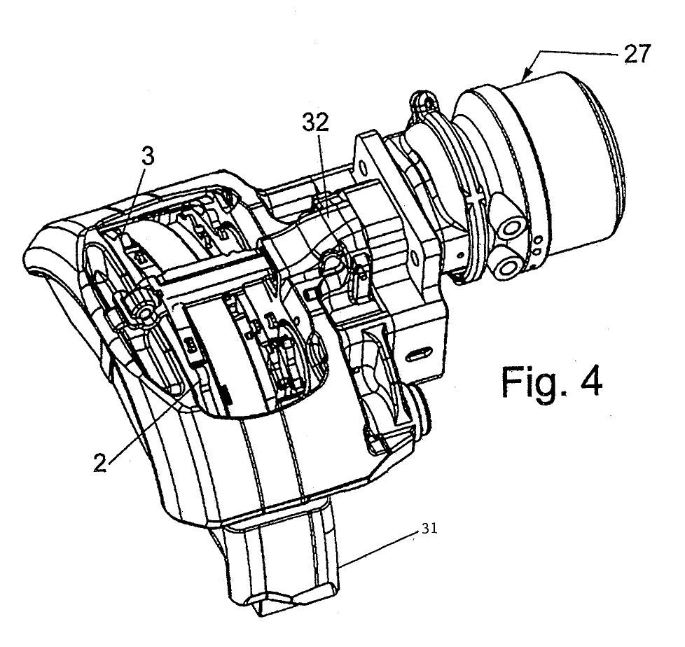

FIG. 5 shows a schematic sketch of a portion of the brake to illustrate considerations involved in the design of brakes of the type in FIGS. 1 to 4.

### DETAILED DESCRIPTION OF THE DRAWINGS

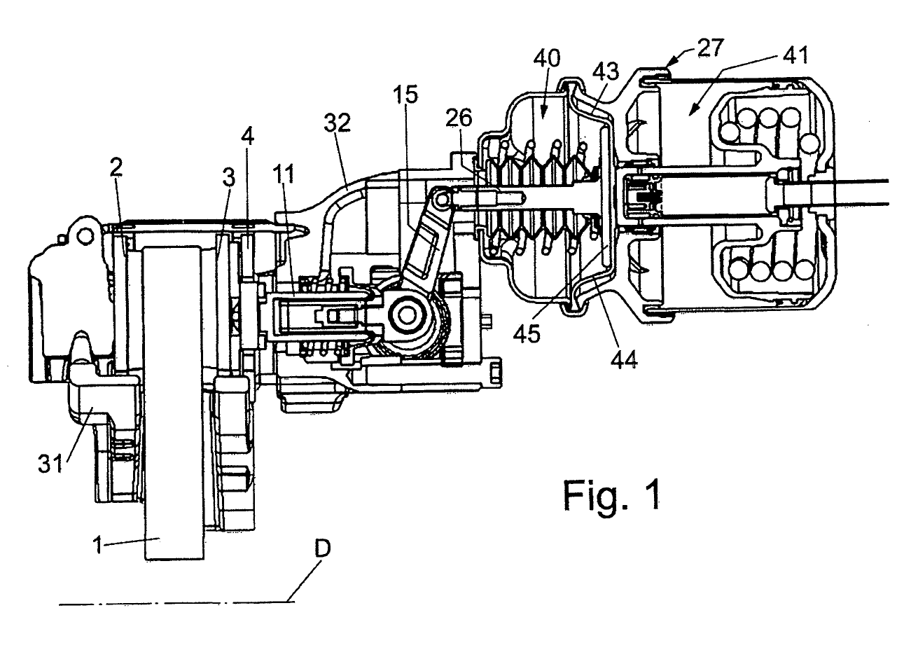

FIG. 1 shows a cross-section of a sliding caliper disc brake with brake linings 2 and 3 arranged on both sides of a brake disc 1.

The embodiment as a sliding caliper disc brake is one possible design form. Developments as floating caliper disc brake or as fixed caliper disc brake or mixed forms combining the types are feasible but are not represented here.

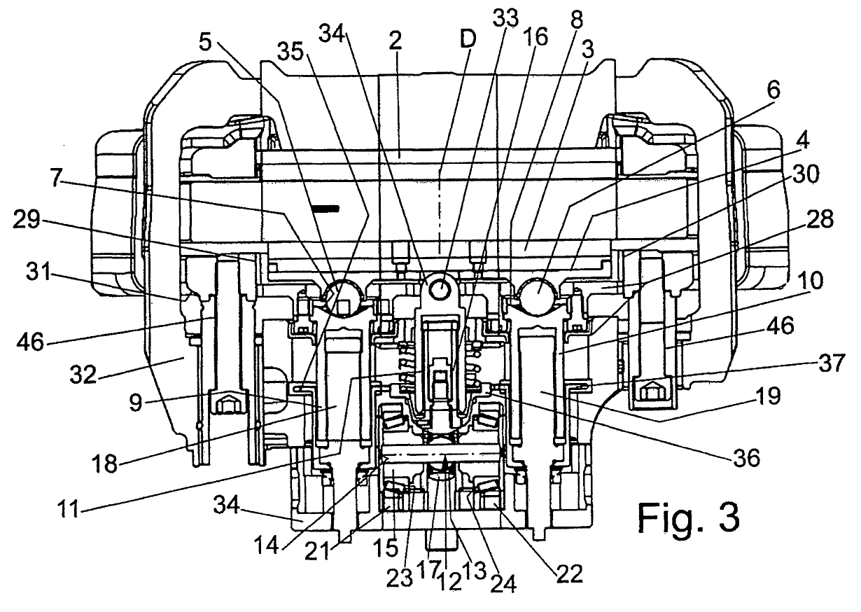

The sliding caliper disc brake includes a single-part or, in this case, a multipart brake caliper 32 (here with a caliper housing section cover), which caliper engages over the brake disc 1 in the peripheral edge area and accommodates a brake application device. The caliper 32 is displaceably guided by means of a caliper sliding guide 46 on a brake carrier 31 fixed to the axle (FIG. 3).

A brake cylinder 27 as force generator, which is attached or formed onto the caliper (FIG. 1), acts by way of a piston rod 26 on a brake rotary lever 15, which is preferably eccentrically supported in the caliper 20 and which, in response to an actuation by the brake cylinder, is capable of swiveling about an axis of rotation oriented perpendicularly to the schematically indicated brake disc axis of rotation D.

The brake rotary lever 15 in turn acts by way of at least one brake piston 11 directly or via a pressure plate on an application-side brake lining 3. At the same time the brake piston 11 and the brake rotary lever 15, and the brake piston 11 and the pressure plate 4 are pivotally connected together such that when the disc brake is applied, the brake piston 11 is fully or at least substantially able to follow a movement of the application-side brake lining 3 in the circumferential direction of the brake disc 1.

Here the brake application device is designed in such a way that compressive force can act on the brake lining 3.

The actuation-side brake lining 3 is accommodated in the pressure plate 4, which may also be integrally formed with the brake application device.

The pressure plate 4 is displaceable parallel to the brake disc friction surface and is operatively connected by way of rolling elements, in this case balls 5 and 6, supported therein to wedge-like ramps 7 and 8 of pressure pistons or adjusting pistons 9 and 10, which are of axially variable length and which are oriented at an acute angle of more than 0 degrees and less than 90° to the brake disc friction surface. The ramps 7, 8 could also be formed or complementarily formed in the pressure plate 4. In this case the balls (or other rolling elements) would be guided in spherical cap-like recesses in the pressure piston, which would nevertheless be part of the self-energizing device.

As already mentioned, the actuation tappet 11 is articulated on the pressure plate 4 in order to transmit the compressive and tensile forces acting in the direction of the brake disc. Here this articulation is afforded by means of a pin 33 and by a fork head 34. In the event of a circumferential displacement of the pressure plate 4, this pivotal connection allows a swiveling movement of an actuation tappet 11 about the ball center 12 (which lies on the eccentric axis of rotation) of a spherical cap bearing 13.

The spherical cap bearing 13 is accommodated on the eccentric axis 14 of the brake rotary lever 15 for transmitting the actuating forces to the actuation tappet 11. The actuation tappet 11 is screwed to a threaded tappet 16, the threaded tappet 16 in turn being firmly connected to a pivot bearing housing 17. The actuation tappet 11 together with the threaded tappet 16 forms a tappet or adjusting piston of variable length for the purpose of wear adjustment.

Similarly the two pressure pistons 9 and 10 are screwed to the threaded spindles 18 and 19, which transmit the bracing force of the pressure pistons 9/10 to the caliper 32.

The threaded spindles 18/19 are connected to the threaded tappet 16 by a synchronization mechanism. This serves to ensure that the rotational drive movement of the adjuster drive only acts synchronously on the two pressure pistons 9 and 10 and the actuation tappet 11.

The rotary lever 15 is supported in the two bearing brackets 21/22 by way of two low-friction rolling bearings 23/24. The bearing brackets 21/22 are firmly connected to the housing section of the caliper 32. The piston rod 26, which serves to transmit compressive actuation forces, is attached to or articulated on the lever arm of the brake rotary lever 15.

At their end facing the brake disc 1, the pressure pistons 9/10 are accommodated in a guide plate 28 and configured in such away that bracing forces acting on the ramps 7/8 parallel to the brake disc friction surface are introduced into the guide plate 28 and dissipated from the latter to the brake carrier 31 at the guide faces 29 or 30, depending on the direction of rotation of the brake disc.

At their end facing the brake disc 1, the pressure pistons 9/10 and the actuation tappet 11 are guided solely by the guide plate 28 and the brake carrier 31.

The caliper 32 and the adjusting device mechanism 35/36/37 together with the caliper sliding guide are relieved of circumferential forces.

In this case the brake pistons 9, 10 are preferably simply screwed or pressed directly on the guide plate 28.

A braking sequence with this disc brake will be described below by way of example.

When an intention to brake is detected through the actuation of the brake pedal and hence the brake set-point transmitter connected to the brake pedal, compressed air is admitted to the brake cylinder 27 so that the piston rod 26 moves. At the same time the rotary lever 15 is swiveled in its rolling bearings 23/24 and thereby also moves its eccentric shaft 14 and hence the spherical cap bearing 13 according to the lever transmission in the direction of the brake disc. The movement of the spherical cap bearing is transmitted to the pressure plate 4 via the actuation tappet and the component chain 12=>13=>17=>16=>11=>33=>34.

In the process, the pressure plate 4 is first moved towards the brake disc 1 at right angles to its friction surface in order to overcome the air gap with the brake lining 3. When the friction lining 3 is applied to the friction surface of the brake disc 1, the brake lining 3 and the pressure plate 4 connected thereto are carried by the resulting frictional force of the brake disc 1 in its direction of rotation.

The balls 5/6 are guided along the ramps 7/8, intensifying the movement of the pressure plate 4 towards the brake disc, in addition to the circumferential movement of the plate as a self-energizing device.

Here, the application force introduced by the actuation tappet 11 is intensified according to the increased expansion of the caliper 32. Owing to the circumferential displacement of the pressure plate 4, the actuation tappet 11 performs a swiveling movement around the spherical cap bearing 13 and the pin 33. As is usual in sliding caliper brakes, the reaction side brake lining 2 is applied to the brake disc 3 as a result of a displacement of the brake caliper. There is no need here to provide a self-energizing device.

Here the brake cylinder 27 is embodied as a combination cylinder, which comprises a service brake section 40 and a parking brake section 41.

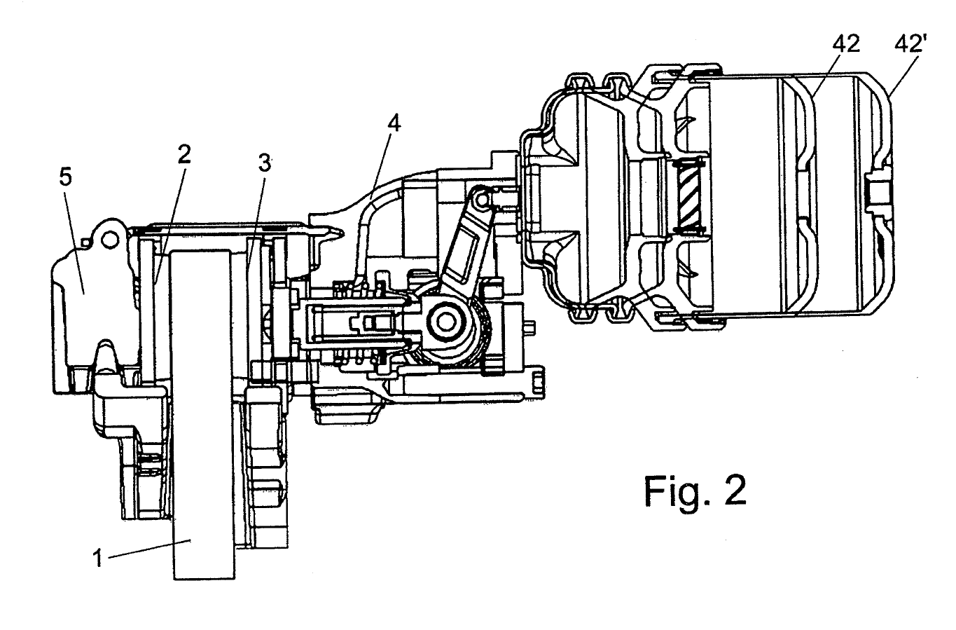

From a comparison of two brake cylinder housings 42 and 42′, FIG. 2 illustrates that the type of brake application device 10 of the disc brake in self-energizing form makes it possible to use a smaller brake cylinder than would be possible without the self-energizing design (see the brake cylinder 42′).

The service brake cylinder section 40 is designed as a diaphragm cylinder, which has a chamber 43 to which compressed air can be admitted, the admission of compressed air, by way of a diaphragm 44 and a plate 45, producing a movement of the piston rod 26, which acts on one end of the eccentrically supported rotary lever 15 of the brake application device.

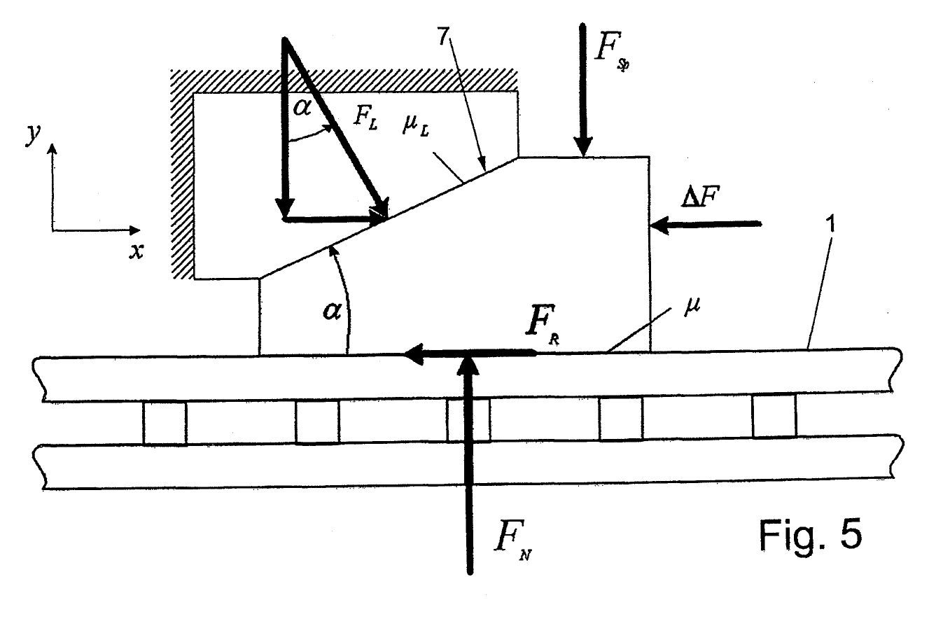

The design of the self-energizing, pneumatically actuated disc brake will be explained in more detail below with reference to FIG. 5.

From the equilibrium conditions in the x and y direction it follows that:

ΣFₓ=0=−F_{R}+F_{L}·sin(α±γ)−ΔF (I)

ΣF_{y}=0=F_{N}−F_{L}·cos(α±γ)−F_{Sp} (II)

Here the angle γ is the friction angle in the wedge ramp (here as at 7 and 8) and can be calculated from the equation γ=arctan(μL). This friction angle has a different influence on the effective wedge angle depending on the direction of movement of the brake lining. When the brake lining moves in the application direction, the friction in the wedge ramp acts in opposition to this movement. The effective wedge angle is therefore increased by the amount of the friction angle γ (return capability of the wedge is increased). In the release direction this correlation is exactly inverse, that is to say the effective wedge angle is reduced by the amount of the friction angle (return capability of the wedge is reduced).

For the application direction therefore:

α_{eff}=α+γ.

and for the release direction

α_{eff}=α·γ

From the equilibrium equation (I) it follows that

$${F}_{L} = \frac{1}{sin ( α \pm γ )} \cdot ( μ \cdot {F}_{N} + Δ F ) ,$$

inserted into (II) produces:

$$\frac{Δ F}{{F}_{N}} = tan ( α \pm γ ) - μ - \frac{{F}_{SP}}{{F}_{N}} \cdot tan ( α \pm γ ) . \qquad ( III )$$

In normal brake operation the ratio is

$$\frac{Δ F}{{F}_{N}} = 0 ,$$

since the actuator (not shown here) compensates fully for the force differential of

F_{N}·(tan(α±γ)−μ).

The actuator can be designed so that it can transmit forces both in a tangential (x) and in a normal direction (y).

In ABS braking it is a question of reducing the application force (F_{N}) as rapidly as possible, in order to prevent the wheel from locking. Looking just at the brake lining, the equation (III) may be rewritten as follows:

$$\frac{Δ F}{{F}_{N}} = tan ( α - γ ) - μ . \qquad ( IV )$$

For the time being the actuator force is disregarded (i.e. F_{SP}=0).
The resulting return force from the wedge must be capable of bringing the lining into the release position sufficiently rapidly and of overcoming the residual actuator force (venting resistance of the cylinder, efficiency of the actuator mechanism and mass inertia). From previous experience the following correlation is arrived at:

$$\frac{Δ F}{{F}_{N}} \geq 0 , 1$$

Table of Reference Numerals

| | |
|---|---|
| Brake disc | 1 |
| Brake linings | 2, 3 |
| Pressure plate | 4 |
| Balls | 5 and 6 |
| Ramps | 7 and 8 |
| Pressure pistons | 9 and 10 |
| Actuation tappet | 11 |
| Ball center | 12 |
| Spherical cap bearing | 13 |
| Eccentric axis | 14 |
| Brake rotary lever | 15 |
| Threaded tappet | 16 |
| Pivot bearing housing | 17 |
| Threaded spindles | 18 and 19 |
| Bearing brackets | 21/22 |
| Rolling bearings | 23/24 |
| Piston rod | 26 |
| Brake cylinder | 27 |
| Guide plate | 28 |
| Guide faces | 29 or 30 |
| Brake carrier | 31 |
| Brake caliper | 32 |
| Pin | 33 |
| Fork head | 34 |
| Adjusting mechanism | 35/36/37 |
| Service brake section | 40 |
| Parking brake section | 41 |
| Brake cylinder housing | 42 and 42′ |
| Chamber | 43 |
| Diaphragm | 44 |
| Plate | 45 |
| Caliper sliding guide | 46 |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A pneumatically actuated disc brake having an application-side brake lining and a reaction-side brake lining that are applied against a brake disc, the disc brake comprising:
a caliper;
a brake application device having a rotary lever for applying the brake linings against the brake disc;
a compressed air-actuated brake cylinder configured to act on the brake application device as a brake force generator;
wherein the disc brake is operably configured such that at least the application-side brake lining is moveable both in a direction parallel to an axis of rotation of the brake disc and parallel to a friction surface of the brake disc; and
a self-energizing device operably configured to have a self-energizing factor selected such that a release of the disc brake occurs automatically after braking.

2. The pneumatically actuated disc brake according to claim 1, wherein the self-energizing factor is selected such that the brake automatically releases after braking even at a maximum possible coefficient of friction.

3. The pneumatically actuated disc brake according to claim 1, wherein the self-energizing factor is less than or equal to 2.2.

4. The pneumatically actuated disc brake according to claim 1, wherein the self-energizing factor is less than or equal to 2.0.

5. The pneumatically actuated disc brake according to claim 1, wherein the rotary lever acts directly or via an intermediate element on at least a single-part or multi-part actuation tappet, said tappet acting directly or via a pressure plate on the application-side brake lining.

6. The pneumatically actuated disc brake according to claim 5, wherein the self-energizing device is connected in parallel to the actuation tappet.

7. The pneumatically actuated disc brake according to claim 1, further comprising at least one adjusting device for adjusting wear of the disc brake.

8. The pneumatically actuated disc brake according to claim 5, wherein the actuation tappet is pivotally supported on the rotary lever and on one of the pressure plate and the application-side brake lining.

9. The pneumatically actuated disc brake according to claim 8, wherein the axes of rotation of the actuation tappet pivotally supported on the rotary lever and on the pressure plate or the application-side brake lining cross one another.

10. The pneumatically actuated disc brake according to claim 8, wherein the actuation tappet is supported on an eccentric axis of rotation of the rotary lever and is attached to the pressure plate or the application-side brake lining such that swivel movements of the rotary lever and circumferential slipping movements of the brake lining are compensated for by swiveling in both swiveling directions perpendicular to one another.

11. The pneumatically actuated disc brake according to claim 10, wherein the actuation tappet has swivel bearings at both ends, where force is transmitted via link pins both on the rotary lever side and on the pressure plate side, a link pin of the rotary lever being arranged with an axis of rotation that crosses relative to a link pin of the pressure plate.

12. The pneumatically actuated disc brake according to claim 5, wherein the actuation tappet comprises an axially variable length actuation tappet unit for compensating wear of the disc brake.

13. The pneumatically actuated disc brake according to claim 12, wherein the axially variable length of the actuation tappet unit is provided by a telescoping action of the actuation tappet unit.

14. The pneumatically actuated disc brake according to claim 5, wherein the actuation tappet is coupled via a synchronization mechanism to an adjusting device for transmitting an adjusting rotational movement.

15. The pneumatically actuated disc brake according to claim 1, further comprising at least one rotational bearing formed on an eccentric axis of the rotary lever as a spherical roller bearing.
